(19) United States
(12) Patent Application Publication
(10) Pub. No.: US 2026/0081055 A1
(43) Pub. Date: Mar. 19, 2026

(54) ELECTRICAL INSULATION DEVICE FOR BUSBAR

(71) Applicant: AMPERE S.A.S., Boulogne Billancourt (FR)

(72) Inventors: Julien BORIE, Guyancourt (FR); Fabien GAUTIER, Guyancourt (FR)

(73) Assignee: AMPERE S.A.S., Boulogne Billancourt (FR)

(21) Appl. No.: 18/998,535

(22) PCT Filed: Jul. 5, 2023
(86) PCT No.: PCT/EP2023/068513

§ 371 Date: Feb. 25, 2025

(30) Foreign Application Priority Data
Aug. 2, 2022 (FR) 2208024

(51) Int. Cl. H01B 17/56

(52) U.S. Cl. CPC H01B 17/56

(57) ABSTRACT

An insulation device for a busbar includes a support and at least one cover made of electrically insulating material and attached to the support. The at least one cover is slidably mounted on the support by at least one guide member.

The invention relates to an electrical insulation device for a busbar and to an insulation assembly comprising such a device. In particular, the busbar concerned is intended for a vehicle, such as an electric or hybrid vehicle. The invention also relates to a method for installing an insulation assembly according to the invention.

Conventionally, busbars, the name given to interconnection bars, are used for interconnecting various modules of an electrical energy storage device also referred to as a battery or battery pack.

In the automotive industry in particular, such busbars are used for electrically interconnecting a plurality of modules so as to form an electrical energy storage device capable of supplying electrical power to a drivetrain of an electric or hybrid vehicle. The use of busbars thus allows the storage and power capacities of distinct modules to be combined.

Nevertheless, the busbars are able to conduct high voltages which may, for example, be of the order of 400 V. It is therefore of overriding importance to protect any technician or user liable to be working on the storage device, notably anybody tasked with fitting or removing it. In particular, in such a context, it is imperative to conform to the IPXXB electrical insulation standard which seeks to prevent a user from coming into contact with a high-voltage live part with their finger.

To this end, as disclosed in international application WO2021/045395, it is known practice to fit insulating housings around components and/or zones that are live. Adopting such a principle may nevertheless prove complicated around the end portions of the busbars, arranged in contact with terminals of the modules, in which regions the busbars are fixed, particularly screw-fastened using screws, to said modules. It is therefore necessary for such end portions to be accessible.

In this respect, it is known practice to use insulating housings comprising the folding flaps or caps. However, such housings have the disadvantage of being bulky, and are ill-suited to use in a confined space because of the space required for enabling the flaps to be opened and closed.

The invention falls within this context and seeks to provide an electrical insulation device for a busbar that overcomes the above disadvantages. In particular, the invention seeks to propose an electrical insulation device that is compact and simple to use.

The invention relates to an electrical insulation device for a busbar, comprising a support made of an electrically insulating material configured to cover a busbar and at least one removable electrically insulating cover attached to the support:
the support comprising at least one orifice, able to extend facing at least one fixing means for fixing a busbar, and a guide slot for guiding the at least one cover;
the at least one cover comprising a body and being slidably mounted on the support via at least one guide member, connected to the body, so as to be able to be moved in the guide slot between a first position in which the at least one orifice is uncovered, and a second position in which the at least one orifice is covered by the body.

Notably, the guide member may comprise:
a retaining member for retaining the cover relative to the support, the retaining member comprising a deformable portion, notably in the form of a clip, configured to collaborate with at least one edge of the guide slot so as to prevent the cover from moving relative to the support in at least one direction; and/or
at least one positioning member for positioning the cover in at least one of either the first or the second positions, the guide slot comprising at least one positioning element, such as a recess, having a shape that complements that of said positioning member, delimiting said position.

The body of the at least one cover may comprise a grasp-promoting member, arranged on an end side of the body and configured to extend as a projection from the support in at least one direction.

In particular, the insulation device may comprise a plurality of covers. The support then comprises a plurality of guide slots, each of said slots being configured to collaborate with one of the covers of the plurality of covers.

According to one embodiment option, the support may comprise at least one wall and at least one attached removable portion configured to be fixed on the at least one wall, said removable portion comprising the at least one orifice and the guide slot for guiding the at least one cover.

Equally, the support may comprise a poka-yoke slit passing through the thickness of the support and opening into the at least one orifice, the cover comprising a poka-yoke means projecting out from the body and configured to collaborate with the poka-yoke slit so as to extend through the latter and project from the support.

Advantageously, the insulation device may further comprise a marking arranged on the support and indicating the correct or incorrect positioning of the at least one cover, the cover being configured to at least partially cover said marking according to whether it is in the first position or the second position.

The invention also relates to an electrical insulation assembly for a busbar comprising an insulation device according to the invention and a busbar.

The electrical insulation assembly may further comprise at least one fixing means arranged facing the at least one orifice and mounted on the busbar, the fixing means being a captive screw.

The electrical insulation assembly may also be configured so that:
the support is overmolded on the busbar; or
the insulation assembly further comprises an electrically insulating baseplate configured to collaborate with the support, the baseplate extending at least on one side of the busbar and the support extending at least on an opposite side of the busbar relative to the baseplate.

The invention may also extend to a cover for an electrical insulation device for a busbar as explained hereinabove, the cover being made from an insulating material and comprising:
a body, notably one that is flat or substantially flat;
at least one guide member connected to the body and projecting out therefrom, the guide member being configured to collaborate with, and to be moved relative to, a support, being moved in the guide slot between a first position.

The invention finally relates to a method for installing an electrical insulation assembly according to the invention, comprising positioning the busbar on a module of the electrical energy storage device, positioning at least one fixing means so as to fix the busbar to said module, and moving the at least one cover from the first position to the second position by sliding relative to the support.

Further details, features and advantages will become more clearly apparent from reading the detailed description given below by way of non-limiting indication, in relation to the various embodiment examples illustrated in the following figures:

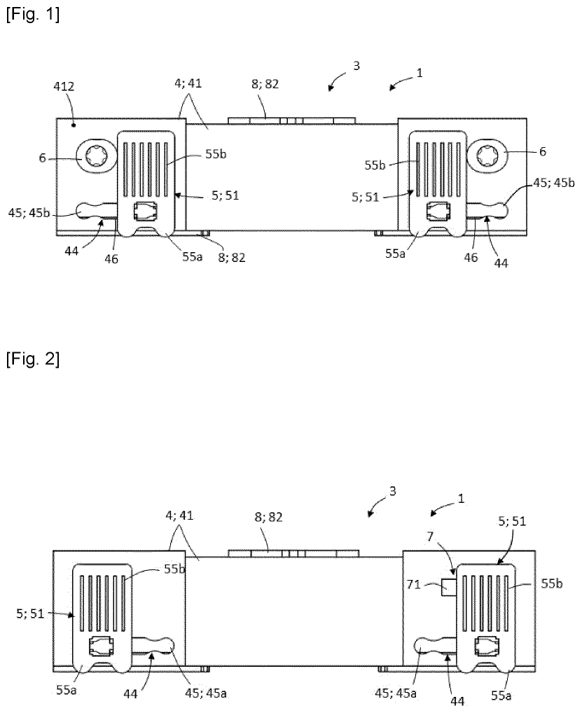

FIG. 1 is a schematic depiction of one embodiment of an assembly and of a device for electrical insulation of a busbar.

FIG. 2 is a schematic depiction of the assembly and of the device for electrical insulation of a busbar.

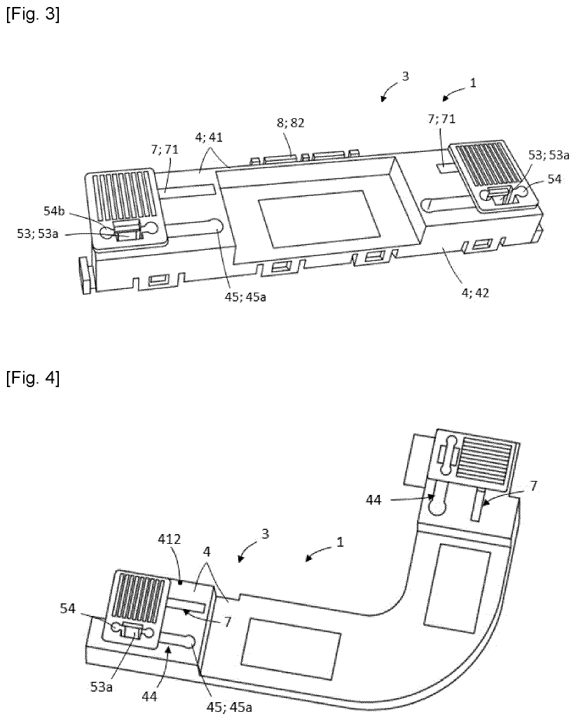

FIG. 3 is a schematic depiction, in perspective, of the assembly and of the device for electrical insulation of a busbar.

FIG. 4 is a schematic depiction of one alternative example of embodiment of the assembly and of the device for electrical insulation of a busbar.

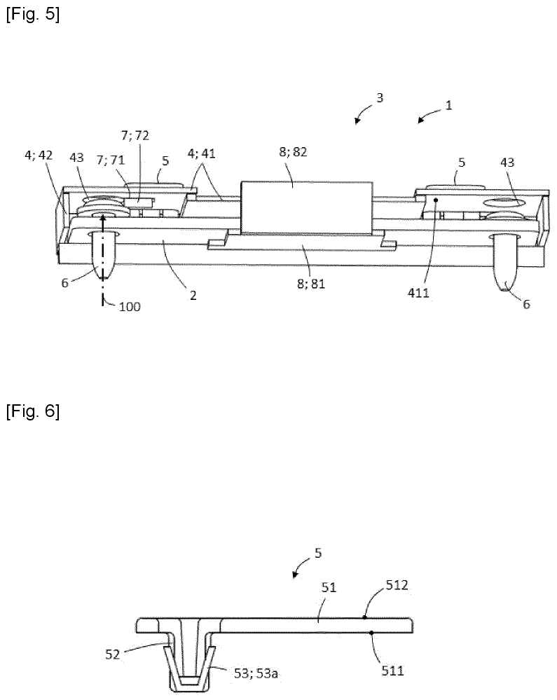

FIG. 5 is a schematic depiction of fixing means and of a poka-yoke device comprised in the electrical insulation assembly.

FIG. 6 is a schematic depiction of a cover for an electrical insulation assembly.

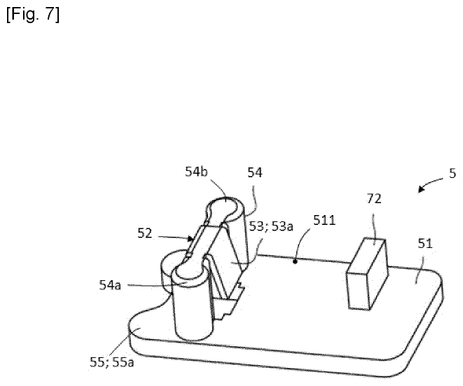

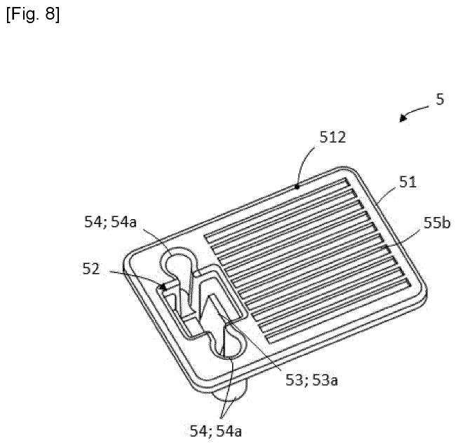

FIG. 7 is a schematic depiction, in perspective, of the cover comprising a guide member.

FIG. 8 is a schematic depiction, in perspective, of the cover.

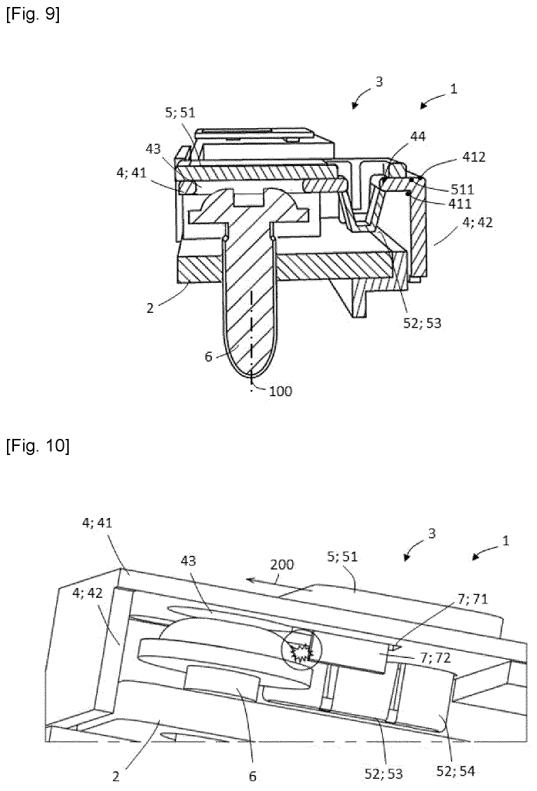

FIG. 9 is a schematic depiction, in cross section, of the electrical insulation assembly.

FIG. 10 is a schematic depiction of the operation of the poka-yoke device of the electrical insulation assembly.

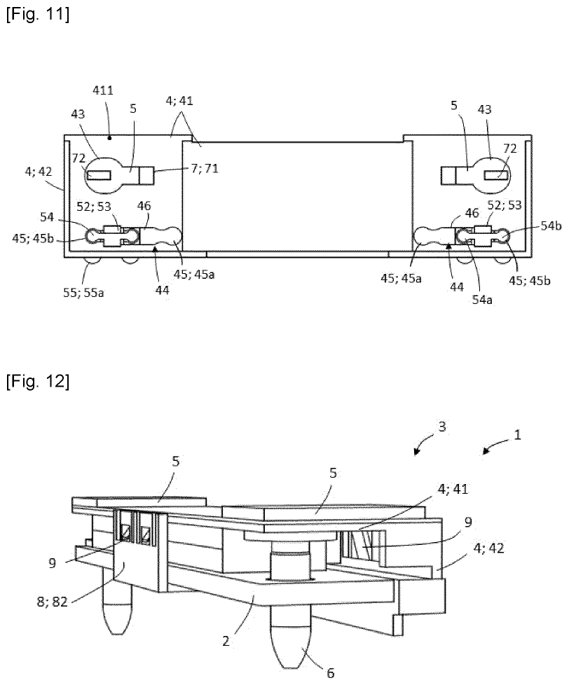

FIG. 11 is a schematic depiction of the positioning of the cover in the electrical insulation assembly.

FIG. 12 is a schematic depiction of an electrical insulation assembly according to a first embodiment, comprising a baseplate.

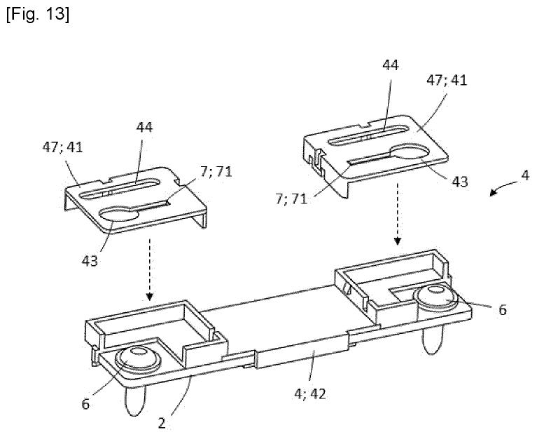

FIG. 13 is a schematic depiction of one embodiment option of a support of the device for electrical insulation of a busbar.

FIG. 1 schematically illustrates one exemplary embodiment of an electrical insulation assembly 1 for a busbar 2 which is another name for an interconnection bar. The electrical insulation assembly 1 notably comprises a busbar 2 and an electrical insulation device 3 according to the invention.

The busbar 2 may be a bar that is straight, which is to say rectilinear, or substantially straight, as illustrated in FIGS. 5, 10 and 11. Alternatively, the busbar 2 may be a bar that is curved. It must be appreciated that the description given hereinafter with reference to an insulation assembly 1 comprising a busbar 2 that is straight, or with reference to an insulation device 3 for a busbar 2 that is straight, applies mutatis mutandis to a busbar 2 that is curved.

In particular, according to the invention, the busbar 2 concerned may be a busbar 2 intended for electrically connecting modules comprised in an electrical energy storage device also referred to as a “battery”. Notably, the storage device concerned is able to supply electrical power to a drivetrain of an automotive vehicle. The vehicle is notably a vehicle with an electric or hybrid power unit. The vehicle concerned may be of any type, for example a private automobile, a utility vehicle, a truck or a bus. Notably, the vehicle may be a vehicle with an on-line connection and/or an autonomous vehicle.

FIGS. 1 to 12 illustrate examples of embodiment of an insulation assembly 1 or of an insulation device 3 according to the invention. Throughout the description that follows, the terms “first”, “second”, “primary”, “secondary”, “main” are intended to make a distinction between similar components rather than to define a hierarchical order within the subject matter.

In general, the insulation device 3 for a busbar 2 according to the invention comprises a support 4 configured to cover the busbar 2, and at least one removable cover 5 attached to the support 4.

The support 4 is made from an insulating material, notably from a plastics material such as an LCP (Liquid Crystal Polymer). The support 4 comprises a main wall 41 configured to cover the busbar 2. Notably, the main wall 41 is configured to be interposed between the busbar 2 and the hand of a user in a first direction 100. As a preference, the main wall 41 is at least partially flat or substantially flat.

According to alternative embodiments detailed more fully later, the main wall 41 may be produced as a single piece or may be formed of a plurality of parts lying in the one same plane or substantially in the one same plane.

The support 4 notably forms at least a half-housing. As a preference, the support 4 further comprises a plurality of lateral walls 42, extending from the main wall 41. Notably, according to the exemplary embodiment illustrated, the support 4 comprises at least three lateral walls 42. These are perpendicular, or substantially perpendicular, to the main wall 41, extending in such a way as to surround the busbar 2 at least in part. Notably, the lateral walls 42 are arranged, within a storage device, so that they surround the accessible zones of the busbar.

The support 4 has a shape suited to the busbar 2. Notably, the support may have a parallelepipedal or substantially parallelepipedal shape in the case of a straight busbar 2, as illustrated in FIGS. 1 to 3. Conversely, when the busbar 2 has a curved shape, as explained earlier, the support may have a curved shape, as illustrated in FIG. 4.

The support 4 has at least one through-orifice 43. The at least one orifice 43, as visible in FIG. 5 or 9, is located in the main wall 41 so as to extend between a first face 411, that faces toward the busbar 2, and a second face 412, on the opposite side therefrom.

The at least one orifice 43 is positioned in such a way as to extend facing at least one fixing means 6, such as a screw, for fixing the busbar 2 when these are assembled within the insulation assembly 1 or within the electrical energy storage device. In this particular instance, the at least one orifice 43 is positioned facing the at least one fixing means 6 in the first direction 100. A head of the fixing means 6 and the at least one orifice 43 may, as a preference, be centered on the one same axis. The at least one orifice 43 thus renders the fixing means 6 accessible by means of a tool, such as a screw-driving tool, for example so that, in the case of a screw, this screw can be tightened.

Optionally, as detailed more fully later, the at least one orifice 43 may be dimensioned so as to have a main dimension that is strictly smaller than a main direction of a head of the fixing means 6 concerned. What is meant by a “main dimension” is the longest dimension, measured in a direction orthogonal to the first direction 100, of the orifice 43. Such a main direction may, for example, correspond to a diameter in the case of a circular orifice 43 or to a diagonal, in the case of a polygonal orifice 43.

Preferably, the support 4 comprises a number of orifices 43 that is equal to the number of fixing means 6 used for holding the busbar in place. Each orifice 43 is then positioned so that it extends facing a fixing means 6 that is specific to it, according to a principle similar to that set out above. In this particular instance, the busbar 2 is held in place by two fixing means 6 and the support 4 comprises two orifices 43.

Furthermore, the support 4 comprises at least one guide slot 44 for guiding the at least one cover 5. In a similar way to the orifice 43, the at least one slot is a through-slot, which is to say that it is located in the main wall 41 in such a way as to extend between the first face 411 and the second face 412. According to the example illustrated, the guide slot 44 may be rectilinear or substantially rectilinear. According to an alternative that has not been depicted, the guide slot 44 may be at least partially curved. As detailed more fully later, the guide slot 44 is configured to at least partially accept the cover 5 so as to allow the latter to move relative to the support 4.

The insulation assembly 1 for a busbar 2 according to the invention may also be embodied in different ways.

According to a first embodiment, illustrated in FIG. 5 or 12, the insulation assembly 1 may further comprise an electrically insulating baseplate 8, attached to and configured to collaborate with the support 4. The support 4 and the baseplate 8 then each form a half-housing the combination of which defines a housing, which may or may not be closed, at least partially surrounding the busbar 2. Notably, the baseplate 8 may be connected to the support 4 via at least one fixing element 9 such as a clip-fastening fixing. The baseplate 8 extends at least on one side of the busbar 2, whereas the support 4 extends at least on an opposite side of the busbar 2 relative to the baseplate 8. In other words, the baseplate 8 and the support 4 are at least positioned one on each side of the busbar 2, in the first direction 100.

According to alternative embodiments, the baseplate 8 may have a U-shaped or L-shaped profile. Notably, the baseplate 8 comprises a main flank 81, extending on the opposite side of the busbar 2 relative to the main wall 41 of the support 4. The main flank 81 extends in contact with the busbar 2. The baseplate 8 may further comprise one or more lateral flanks 82 which are connected to the main flank 81 and configured to collaborate with at least one lateral wall 42 of the support 4. The baseplate 8 thus indirectly makes the connection between the busbar 2 and the support 4. In the nonlimiting alternative illustrated, the baseplate 8 has a U-shaped profile with two lateral flanks 82.

Advantageously, though optionally, in order to simplify the transport and fitting of the insulation assembly 1, the latter may further comprise at least one fixing means 6, positioned facing the at least one orifice 43 and mounted on the busbar 2.

In the case of an insulation assembly 1 comprising a support 4 overmolded onto the busbar 2, the assembly may comprise one or more removable fixing means. The orifice 43 configured to extend facing each of the fixing means 6 concerned is then dimensioned so as to allow said fixing means 6, notably a head thereof, to be inserted and pass through. Alternatively and advantageously, in order to simplify the transport and handling of the insulation assembly 1, the fixing means 6 may be a captive screw. The orifice 43 concerned then preferably has a main direction that is strictly smaller than that of a head of the fixing means 6. The overmolding of the support 4 is then performed on the busbar 2 fitted with one or more fixing means so that these means extend into a volume delimited by the support 4. The support 4 then advantageously forms a captivity housing, also referred to as a captivity cage, namely a space in which the one or more fixing means is or are held captive.

According to a second embodiment which has not been depicted, the support 4 may be overmolded on the busbar 2. This support has, for example, the features set out hereinabove and may further comprise an additional wall, on the opposite side from the main wall 41, so as to define a housing, which may or may not be closed, surrounding the busbar 2, which is to say extending on both sides of the busbar 2 in at least one direction. Notably, the insulation assembly 1 may have a structure similar to that explained hereinabove with reference to the first embodiment, the difference being that the support 4 and the baseplate 8 form an at least partially one-piece assembly overmolded onto the busbar 2 and defining the housing. For example, at least the main wall 41 and one of the lateral flanks 82 of the baseplate form a one-piece assembly overmolded onto the busbar.

In the case of an insulation assembly 1 according to the first embodiment, comprising the removable baseplate 8, the assembly may also comprise one or more removable fixing means. In a way similar to that described earlier, the orifice 43 configured to extend facing each of the fixing means 6 concerned may be dimensioned so as to allow said fixing means 6, notably a head thereof, to be inserted and pass through. Alternatively and advantageously, the fixing means 6 may be a captive screw. The orifice 43 concerned then preferably has a main direction that is strictly smaller than that of a head of the fixing means 6. The support 4 and the baseplate 8 are assembled in such a way as to surround the busbar 2 fitted with one or more fixing means so that these means extend into a volume delimited by the combination of the support 4 and of the baseplate 8. Such a combination then forms a captivity housing, as described above.

The at least one cover 5 is a part that is removable, attached to the support 4. It is configured to be able to move relative to said support 4, notably relative to the main wall 41. The description hereinafter, given with reference to one cover 5, may extend to a plurality of covers 5 comprised in the insulation device 3 according to the invention.

The cover 5 is made from an electrically insulating material, such as a plastics material, notably polyamides such as PA6, for example PA6-GF25. It comprises a body 51. Notably, in order to reduce the overall bulk generated, such a body 51 has a profile having a shape that complements that over at least part of the support 4 with which it collaborates. In this particular instance, the body 51 has a profile having a shape that complements the main wall 41. In the example illustrated, the main wall 41 is flat, or substantially flat, and the same is true of the body 51. In that way, when the cover 5 is assembled on the support 4, a first face 511 of the body 51 of the cover 5, which face faces toward the support 4, extends in contact with the second face 412 of the support 4. According to an alternative which has not been depicted, when the support 4, notably the main wall 41, has a curved profile, the body 51 of the cover 5 has a profile of complementing shape.

The cover 5 further comprises at least one guide member 52. The guide member 52 is connected to the body 51 and projects out therefrom in at least one direction. It extends from the first face 511 of the body 51 and, when the insulation device 3 is assembled, extends toward the support 4. The guide member 52 is configured to collaborate with the guide slot 44 so as to allow the cover 5 to move relative to the support 4. In particular, the guide member 52 is configured to be inserted in the guide slot 44 so as to allow the cover 5 to be moved by sliding between a first position and a second position.

As illustrated in FIG. 1, the body 51 and the support 4 are both configured so that, in the first position, the at least one orifice 43 is uncovered, which is to say accessible, so as to allow a user to operate on the fixing means 6 positioned facing the orifice 43 concerned. Conversely, as depicted in FIG. 2, 3 or 4, when the cover 5 is moved into the second position, the body 51 covers the at least one orifice 43, thus rendering it inaccessible. The body 51 is thus dimensioned according to the position of the at least one orifice 43 concerned and of the guide slot 44 concerned so as to cover the at least one orifice 43 when the cover 5 is inserted in the guide slot 44 and positioned in the second position.

As a preference, the body 51 and the guide member 52 form a one-piece entity, meaning that they cannot be detached from one another without resultant damage to, or even destruction of, the cover 5. For example, the cover 5 may be a molded component.

The guide member 52 has an elongate shape the profile of which is configured to collaborate with the guide slot 44. Optionally, but preferably, the guide member 52 comprises a retaining member 53 for retaining the cover 5 relative to the support 4. The retaining member 53 comprises a deformable portion 53a, notably an elastically deformable portion, configured to prevent the cover 5 from moving relative to the support 4 in at least one direction. In particular, the retaining member 53 is configured to limit the movement of the cover 5 relative to the support 4 in one sense of the first direction 100 so as to prevent the cover 5 from becoming detached.

All or part of the deformable portion 53a is configured to be deformed at the time of assembly of the cover 5 on the support 4, from a “rest” configuration to a “deformed” configuration. Notably, the deformable portion 53a is in the form of a clip fastening. Nonlimitingly, the retaining member 53, particularly the elastically deformable portion 53a, comprises at least one tab. In this particular instance, the retaining member 53 comprises two tabs arranged in such a way as to lie in a V-shaped or substantially V-shaped profile, in the “rest” configuration thereof. The tabs are thus inclined, relative to the first direction 100, so as to come into abutment with the support 4 in the event of movement in the first direction 100 when the cover is in its “rest”configuration.

For each tab concerned, the retaining member 53 is configured in such a way that the free end of said tab extends at a non-zero distance from the first face 511 of the body 51 of the cover 5. Thus, as a preference, when the cover 5 is collaborating with the support 4, the cover 5 is engaged with at least one of the walls of the support 4. In that way, as explained in greater detail later, the cover 5 may notably be indirectly, via at least the support 4, secured to the busbar 2. In this particular instance, the body 51 of the cover 5 on the one hand, and the retaining member 53 on the other hand, notably the elastically deformable portion 53a thereof, are engaged with the main wall 41 in the first direction 100. The body 51 is thus in contact with the second face 412 of the main wall 41 whereas the free end of at least one of the tabs is in contact with the first face 411 of the main wall 41.

At the time of assembly of the cover 5 on the support 4, edges of the guide slot 44 apply force to the retaining member 53, which deforms in order to allow the guide member 52 to be inserted into the guide slot 44. In this particular instance, the deformable portion 53a is moved in such a way that, in the “deformed” configuration, free ends of the tabs move closer toward one another in order to allow the cover 5 to be positioned on the support 4. When the body 51 of the cover 5 is extending in contact with the support 4, the edges of the guide slot 44 are no longer in direct contact with the retaining member 53. The force applied to the retaining member 53 ceases, and the retaining member 53 autonomously returns to its “rest” configuration. The tabs are therefore able to limit the movement of the cover 5 relative to the support 4 by contact with the main wall 41 in the event of the cover 5 moving in the first direction 100, the main wall 41 acting as an end stop for said tabs.

A similar principle may be applied mutatis mutandis to a retaining member 53 comprising a single tab configured to collaborate with at least one edge of the guide slot 44 or comprising more than two tabs.

Furthermore, optionally, but preferably, the guide member 52 may comprise at least one positioning member 54 for positioning the cover 5 in at least one of either the first or the second positions. The guide slot 44 then comprises at least one positioning element 45 for positioning the cover 5, and having a shape that complements that of said positioning member 54, delimiting or delineating the relevant position in which the cover 5 is to be placed relative to the support 4.

In particular, the cover 5 comprises as many positioning members 54 as the support 4 comprises positioning elements 45. In the exemplary embodiment illustrated, the guide member 52 comprises two positioning members 54, whereas the support 4 comprises two positioning elements 45, particularly recesses. A first positioning member 54a and a first recess 45a delineate the first position, in which the at least one orifice 43 concerned is uncovered when the cover 5 is moved in such a way as to position the first member 54a in the first recess 45a. Conversely, a second positioning member 54b and a second recess 45b delineate the second position, in which the at least one orifice 43 concerned is covered by the cover 5 when the latter is moved in such a way as to position the second member in the second recess 45b.

The positioning members 54 and the positioning elements 45 thus also serve as indexing means in so far as they impose a position and an orientation of the cover 5 relative to the support in the first position and in the second position.

In the nonlimiting example illustrated, the guide slot 44 comprises a straight intermediate portion 46 extending along a main axis of extension orthogonal to the first direction 100. Alternatively, such an intermediate portion 46 may be curved, for example in the case of a curved guide slot 44 as explained earlier. The first recess 45a and the second recess 45b are positioned at the extreme ends of the guide slot 44. They are connected to the intermediate portion 46 and extend in the continuation thereof along the main axis such that the cover 5 can be moved into the first recess 45a or into the second recess 45b as a continuation of a sliding motion that passes via the intermediate portion 46. In other words, the intermediate portion 46 here corresponds to intermediate positions of the cover 5, these positions being comprised between the first position and the second position. Alternatively, the recess concerned may be offset relative to the direction defined by the main axis, for example so as to extend above or below such an axis.

Notably, within the guide slot 44, the positioning elements 45, which is to say the first recess 45a and/or the second recess 45b, may be connected to the intermediate portion 46 by, or at, indexing counterforms that contribute to delimiting the open position or the closed position. In this particular instance, such counterforms have the shape of a portion of the guide slot 44 at which the edges of said slot are closer together. Such counterforms create resistance requiring additional effort on the part of a user to move the cover 5 into or out of the position concerned, thus allowing the cover to remain stable in said position.

Also, in the example illustrated, the first positioning member 54a and the second positioning member 54b preferably have a rounded, for example substantially circular, shape and the recesses have a complementing shape. The purpose of such shaping is to lock the indexing of the cover 5 in the open or closed position as explained earlier to complement the female shapes formed by the first recess 45a and/or the second recess 45b.

The intermediate portion 46 and the positioning elements 45a, 45b are each dimensioned in such a way as to allow the cover 5 to move relative to the support 4. In this respect, the intermediate portion 46 and the positioning elements 45 have a width that is strictly greater than a width of the positioning members 54. The widths concerned are the dimensions defined in a direction orthogonal to the first direction 100 and notably orthogonal to the main axis along which the guide slot 44 extends.

Furthermore, as a preference, the positioning members 54 are connected to the body 51 by a structure having solid walls, unlike the retaining member 53 illustrated as an example. Thus, optionally, the positioning members 54 comprise at least one solid wall configured to be situated facing the edges of the guide slot 44 in the first direction 100, when the insulation device 3 is assembled. Notably, the positioning members 54 extend at least partially in contact with the support 4 so as to allow optimized movement of the cover 5 relative to the support 4 and prevent the cover 5 from pivoting in a direction other than the direction or directions in which the guide slot 44 extends.

Optionally, the body 51 of the cover 5 may advantageously comprise at least one grasp-promoting member 55 the purpose of which is to make the cover 5 easier to manipulate. The grasp-promoting member 55 may notably be arranged on an end side of the body 51. In particular, the at least one grasp-promoting member 55 may be configured to extend as a projection from the support 4 in at least one direction. In the example illustrated, the grasp-promoting member 55 has the shape of two protuberances 55a projecting out from the support 4, notably from one of the lateral walls 42, in at least one direction, for example in a third direction orthogonal to the first direction 100 and to the second direction 200.

According to another exemplary embodiment, the cover 5 may comprise, in addition or as an alternative, a grasp-promoting member 55 comprising embossings, striations and/or ridges. Such a grasp-promoting member 55b may be arranged on that face of the cover 5 that is accessible when this cover is assembled in the insulation device 3. In this particular instance, the grasp-promoting member 55 concerned comprises striations on the second surface 512 of the body 51 of the cover 5.

The cover 5 may thus optionally comprise a plurality of grasp-promoting members 55 produced in accordance with one or more of the aforementioned alternatives.

As illustrated in FIGS. 1 to 6, the electrical insulation device 3 may comprise a plurality of covers 5. Such covers 5 may be identical to one another or may be produced according to different alternatives and options explained earlier. The support 4 is then able to collaborate with a plurality of covers 5. It comprises a plurality of guide slots 44 as explained earlier, each of said slots being configured to collaborate with one of the covers 5 of the plurality of covers 5.

Furthermore, optionally, but preferably, the electrical insulation device 3 may comprise at least one poka-yoke device 7 in which the support 4 comprises a poka-yoke slit 71 whereas the cover 5 comprises a poka-yoke means 72 configured and shaped to collaborate with such a slit. As illustrated in FIGS. 5 and 10, the poka-yoke means 72 is intended to inform a user of the correct positioning of a defined fixing means 6, as explained more fully later. For example, the poka-yoke means 72 seeks to define whether or not the fixing means 6 concerned has been tightened adequately for holding the busbar 2 in place.

The poka-yoke slit 71 is comprised in the wall comprising the at least one orifice 43. In this particular instance, the poka-yoke slit 71 is comprised in the main wall 41 of the support 4. The poka-yoke slit 71 passes through the thickness of the support 4, which means to say here extends from the first face 411 of the main wall 41 to the second face 412. The poka-yoke slit 71 is configured to extend parallel, or substantially parallel, to the guide slot 44. In a similar way to that which was explained earlier, the poka-yoke slit 71 may be straight or at least partially curved. Also, the poka-yoke slit 71 defines a path for the travel of the cover 5 that is similar, or substantially similar, to a path defined by the guide slot 44. The poka-yoke slit 71 extends at a non-zero distance from the guide slot 44 and opens into the at least one orifice 43.

In order to collaborate with the poka-yoke slit 71, the poka-yoke means 72 comprised in the cover 5 may have the form of a finger, of a pin or of a tab projecting out from the body 51. The poka-yoke means 72 and the guide member 52 extend from the one same side of the body 51 of the cover 5. The poka-yoke means 72 is dimensioned to have, in the first direction 100, a dimension that is strictly greater than the thickness of the wall of the support 4 comprising the poka-yoke slit 71 so that it projects out beyond said wall when the cover 5 is assembled on the support 4. In this particular instance, when the cover 5 is mounted on the support 4, the poka-yoke means 72 extends through the poka-yoke slit 71 and projects from the first face 411 of the main wall 41 of the support 4.

The poka-yoke device 7 is thus configured in such a way that, when the cover 5 is moved in the guide slot 44 relative to the support 4, the poka-yoke means 72 is at the same time moved along the poka-yoke slit 71. As illustrated in FIGS. 5 and 10, because of the positioning of the poka-yoke slit 71 relative to the at least one orifice 43, the poka-yoke device 7 is configured so that the poka-yoke means 72 comes into abutment with the fixing means 6 arranged facing the orifice 43 concerned in the first direction 100 when said fixing means 6 is not positioned suitably for holding the busbar 2 in place, for example is not adequately tightened in the case of a screw, while at the same time the cover is moved toward the second position. In other words, if the fixing means 6 is not in a suitable position, it lies across the path of the poka-yoke means 72 and prevents the latter from reaching the second position. The poka-yoke device 7 then prevents the cover from being positioned in the second position and thus makes it possible to prevent incorrect installation of the busbar 2.

The insulation device 3 may advantageously comprise a plurality of poka-yoke devices 7 as explained above. Notably, the insulation device 3 may be configured so that each orifice 43 that it comprises is connected to a poka-yoke slit 71 specific to a poka-yoke device 7.

According to another embodiment option, the insulation device 3 may further comprise a marking arranged on the support 4 and indicating the correct or incorrect positioning of the at least one cover 5. The marking is arranged on a wall of the support 4 that is visible to a user and, for example in the example illustrated, on the main wall 41. According to one exemplary embodiment, such marking may be lettered/or colored, for example to indicate the word “OK” for a correctly-positioned cover 5, namely a positioning in which the insulation device or assembly 1 is ready for use. The insulation device 3 is configured in such a way that the cover 5 at least partially covers said marking according to whether it is in the first position or the second position. For example, when the cover 5 is in the first position so that at the same time at least one orifice 43 and therefore potentially the fixing means 6 arranged facing same is visible, a portion of the marking indicative of inappropriate positioning of the cover 5 is visible. Such part of the marking may, for example, be a marking in red and/or of the “Not OK” or “NOK” type. Conversely, when the cover 5 is in the second position, it covers the at least one orifice 43 and a portion of the marking indicative of correct positioning of the cover 5 may be visible. For example, such a part of the marking may be a marking in green and/or of the “OK”type.

According to yet another embodiment option, illustrated in FIG. 13 and which may be applied to the first embodiment or to the second embodiment as explained earlier, the support 4 may comprise at least one attached removable portion 47, configured to be fixed to at least one wall of the support, for example to part of the main wall 41 and/or to at least one of the lateral walls 42. Said removable portion 47 may, according to a preferred embodiment, be fixed to the wall concerned via a fixing element such as a clip. The removable portion 47 comprises the at least one orifice 43 and the guide slot 44 for the cover 5 as were described previously. The removable portion 47 is thus configured to collaborate with the cover 5. The removable portion 47 and the at least one wall on which the latter is fixed thus contribute to delimiting a space configured to at least partially receive the fixing means 6. Also, optionally, the removable portion may comprise the poka-yoke device 7. The removable portion 47 may be configured in such a way as to form the main wall 41 or in such a way as to lie in a plane common with said main wall 41. The support 4 may further comprise a plurality of removable portions 47, each configured to collaborate with a distinct cover 5.

The present invention may further extend to a cover 5 for an insulation device or assembly 1 for insulating a busbar 2 according to the invention. Said cover 5 may re-employ all or some of the features explained above with reference to the cover 5. Notably, in general, such a cover 5 is made from an insulating material, comprises a body 51, notably one that is flat or substantially flat, and at least one guide member 52 connected to the body 51 and projecting therefrom, the guide member 52 being configured to collaborate with and be moved relative to a support 4.

The invention finally relates to a method for installing an electrical insulation assembly 1 according to the invention. Such a method comprises positioning the busbar 2 on a module of an electrical energy storage device and positioning at least one fixing means 6 so as to fix the busbar 2 to said module. Notably, in the case of a fixing means 6 such as a screw, the positioning of said fixing means 6 is achieved by screw-driving or tightening. Such positioning may be achieved by means of a tool, which is positioned in such a way as to extend at least partly through the orifice 43 comprised in the support 4 extending facing the fixing means 6 concerned. The positioning of the fixing means 6 is performed when the cover 5 concerned, namely a cover configured to extend facing the orifice 43 concerned, is arranged in the first position, so as to render said orifice 43 accessible to a user. The method according to the invention next comprises, when the fixing means 6 has been suitably positioned, moving the at least one cover 5 from the first position to the second position by sliding relative to the support 4. For example, such sliding is performed in a translational movement, notably in a second direction 200 orthogonal to the first direction 100.

Optionally, the method according to the invention may comprise a sub-step of verifying the correct positioning of the fixing means 6 using a poka-yoke device 7 and/or a marking as explained earlier.

The present invention thus proposes an electrical insulation device for a busbar, notably a busbar configured to connect together different modules of an electrical energy storage device, for example for an electric or hybrid vehicle. The device according to the invention is advantageously configured to ensure user safety while at the same time allowing simplicity of fitting and being suited to use in cramped environments.

The present invention is not, however, limited to the means and configurations described and illustrated here and it also applies to any equivalent means or configuration and to any technically feasible combination of such means insofar as they perform, in fine, the functionalities described and illustrated in the present document.

1-10. (canceled)

11. An electrical insulation device for a busbar, comprising:
a support made of an electrically insulating material configured to cover a busbar and at least one removable electrically insulating cover attached to the support, wherein
the support comprises at least one orifice, configured to extend facing at least one fixing means for fixing a busbar, and a guide slot configured to guide the at least one cover, and
the at least one cover comprises a body and being slidably mounted on the support via at least one guide member, connected to the body, so as to be moved in the guide slot between a first position in which the at least one orifice is uncovered, and a second position in which the at least one orifice is covered by the body.

12. The insulation device as claimed in claim 11, wherein the guide member comprises:
a retaining member configured to retain the cover relative to the support, the retaining member comprising a deformable portion configured to collaborate with at least one edge of the guide slot so as to prevent the cover from moving relative to the support in at least one direction; and/or
at least one positioning member configured to position the cover in at least one of either the first or the second positions, the guide slot comprising at least one positioning element having a shape that complements that of said positioning member, delimiting said position.

13. The insulation device as claimed in claim 12, wherein the deformable portion is a clip.

14. The insulation device as claimed in claim 12, wherein the positioning element is a recess.

15. The insulation device as claimed in claim 11, wherein the body of the at least one cover comprises a grasp-promoting member, arranged on an end side of the body and configured to extend as a projection from the support in at least one direction.

16. The insulation device as claimed in claim 11, further comprising a plurality of covers, the support comprising a plurality of guide slots, each of said slots being configured to collaborate with one of the covers of the plurality of covers.

17. The insulation device as claimed in claim 11, wherein the support comprises at least one wall and at least one attached removable portion configured to be fixed on the at least one wall, said removable portion comprising the at least one orifice and the guide slot to guide the at least one cover.

18. The insulation device as claimed in claim 11, wherein the support comprises a poka-yoke slit passing through a thickness of the support and opening into the at least one orifice, the cover comprising a poka-yoke means projecting out from the body and configured to collaborate with the poka-yoke slit so as to extend through the poka-yoke slit and project from the support.

19. An electrical insulation assembly for a busbar, comprising:
the insulation device as claimed in claim 11; and
the busbar.

20. The electrical insulation assembly as claimed in claim 19, further comprising at least one fixing means arranged facing the at least one orifice and mounted on the busbar, the fixing means being a captive screw.

21. The electrical insulation assembly as claimed in claim 19, wherein:
the support is overmolded on the busbar; or
the insulation assembly further comprises an electrically insulating baseplate configured to collaborate with the support, the baseplate extending at least on one side of the busbar and the support extending at least on an opposite side of the busbar relative to the baseplate.

22. A method for installing the electrical insulation assembly as claimed in claim 19, comprising:
positioning the busbar on a module of an electrical energy storage device;
positioning at least one fixing means so as to fix the busbar to said module; and
moving the at least one cover from the first position to the second position by sliding relative to the support.
